(19) United States
(12) Patent Application Publication
(10) Pub. No.: US 2022/0379304 A1
(43) Pub. Date: Dec. 1, 2022

(54) MICROFLUIDIC SENSOR FOR THE DETECTION OF ANALYTES

(71) Applicant: UNIVERSIDAD DEL PAIS VASCO / EUSKAL HERRIKO UNIBERTSITATEA, Leioa, Vizcaya (ES)

(72) Inventors: Fernando BENITO LÓPEZ, Leioa, Vizcaya (ES); Kepa CASTRO ORTIZ DE PINEDO, Leioa, Vizcaya (ES); Ilaria COSTANTINI, Leioa, Vizcaya (ES); María Dolores RODRÍGUEZ LASO, Leioa, Vizcaya (ES)

(21) Appl. No.: 17/624,986

(22) PCT Filed: Jul. 3, 2020
(86) PCT No.: PCT/ES2020/070433

§ 371 Date: Jul. 26, 2022

(30) Foreign Application Priority Data
Jul. 5, 2019 (ES) P201930628

(51) Int. Cl. B01L 3/00; G01N 21/78

(52) U.S. Cl. CPC B01L 3/502707; G01N 21/78; B01L 2300/047; B01L 2300/14

(57) ABSTRACT

A microfluidic sensor for the detection of analytes in objects includes a contact surface that may be attached to a surface of the object, an inlet hole in the contact surface for the entry of fluids emitted by the object, and a first reservoir which stores an ionic fluid in the form of a polymer matrix. The polymer matrix includes a reactive substance which changes colour when it enters into contact with the analytes of the fluids emitted by the object. It further includes at least one first microfluidic duct which connects the inlet hole to the first reservoir. A system for the detection of analytes, a method for the manufacture of the microfluidic sensor and the use of the microfluidic sensor for the detection of analytes in works of art are also related.

### TECHNICAL FIELD

The disclosure falls within techniques for the detection of analytes, for example, ammonia, chlorides, nitrates, carbonates, bicarbonates, sulphates, dissolved cations, among others, in objects, for example, works of art, buildings, construction materials, etc. It particularly relates to a microfluidic sensor capable of detecting the presence of specific analytes in the objects it monitors in a completely autonomous and effective manner and in real time, and the microfluidic sensor being located in direct contact with the object intended to be monitored.

### BACKGROUND

Research into cultural heritage conservation is focusing increasingly more not only on the identification of degradation factors that affect the heritage, but particularly on the use of innovative weather and environmental monitoring techniques by means of air and contaminant level control systems. These techniques allow a risk level for the conservation of the furniture and real estate works due to the presence of the mentioned degradation factors to be established.

At present, a wide range of instruments are emerging for monitoring contaminants which use devices based on systems designed in miniature (portable and integrated transducers and sensors). These systems typically use remote analytical signal transmission, which allows experimental data to be shared in real time. Furthermore, this involves a savings in time for researchers (data collecting in the field may even require days), as well as greater involvement of the final user, who will be able to know the possible damage, the origin of said damage and even restoration and conservation strategies.

One of the devices most recently developed in this direction is MEMORI® dosimetry technology for monitoring contaminants in indoor spaces proposed by Grøntoft et al. [Assessment of indoor air quality and the risk of damage to cultural heritage objects using MEMORI® dosimetry, Studies in Conservation, 61, 70-82]. This technology has been developed as a tool for measuring and assessing the risk of degradation of cultural heritage objects stored indoors due to exposure to atmospheric contaminants (e.g., O₃, SO₂ and NO₂). However, as pointed out in a recent investigation conducted by Valentini et al. [Smart Portable Devices Suitable for Cultural Heritage: A Review, Sensors, 2018, 18, 2434; doi:10.3390/s18082434], sensors that can be applied directly on the surface of the works of art and that are capable of diagnosing local damage therein have still not been designed.

Furthermore, in the state of the art there are tattoo sensors like the one proposed by Torsi et al. [Organic field-effect transistor sensors: a tutorial review, Chemical Society Reviews, 42, 8612-8628] based on field-effect transistors with organic semiconductors. These sensors monitor the physical and chemical changes occurring during the iteration of materials with contaminants. The use of tattoo sensors applied to human skin for monitoring athletic performance by means of analysing the athlete's sweat is also known.

Methods for the colorimetric detection of analytes have been applied in the state of the art as a rapid tool for the determination and detection of the concentration of various types of analytes in various types of matrices. The colorimetric detection technique uses the capacity of the reagents present in the matrix to associate with the analytes of interest, generating as a result a new component of a colour different from the colour of the original matrix (coloured reaction). The intensity of this reaction will depend directly on the concentration of the analyte. However, these colorimetric detection systems are generally complicated devices consisting of receptacle for reagents, pumps and valves for control of the flow of liquids in the device and detector modules making them expensive and inappropriate for use at the site of the contamination or in the object intended to be monitored.

Microfluidic devices are devices in which fluids are handled and controlled on a microscale or mesoscale in a precise manner. The behaviour of fluids on the microscale may differ from macrofluids in factors such as surface tension, energy dissipation and the fluidic resistance. For example, in microfluidic devices (channels or ducts with diameters from around 100 nanometres to several hundreds of micrometres) the Reynolds number, which characterises the presence of a turbulent flow, is extremely low, whereby the laminar flow is kept constant.

Microfluidics is a multidisciplinary field combining engineering, physics, chemistry, biochemistry, nanotechnology and biotechnology, for applications with a high industrial, economic and social value, and for achieving functional, automated, high-performance devices with multiplex capacity.

The use of said microfluidic devices opens up the possibility of rapid, precise and spot monitoring of the contaminants and degradation factors existing in works of art by means of miniaturised components, in a simple manner, which are concepts that should ideally be implemented in heritage conservation and monitoring activities.

However, no solutions using microfluidic devices for monitoring said contaminants and degradation factors in the works of art and heritage are known to date. At present, there are no solutions capable of performing a continuous monitoring of cultural heritage (buildings, sculptures, paintings, photographs, murals, etc.) making use of all the beneficial characteristics of microfluidic devices (small dimensions, portability, detection in situ, continuous monitoring, low cost, ease of use, etc.).

### SUMMARY

Therefore, there is a need, for example, in the fields of (cultural heritage) conservation and restoration, for sensors which can be attached directly to the surface of the works of art or on the constructed surface of the cultural heritage asset and can diagnose or predict local damage. Sensors of this type allow a continuous monitoring, as needed, of the works of art. Furthermore, these sensors can be combined with environmental sensors to provide a holistic monitoring of the work of art and its environment.

The disclosure provides a solution to the mentioned problems by means of a microfluidic sensor for the detection of analytes in objects, a system for the detection of analytes, a method for the manufacture of a microfluidic sensor for the detection of analytes in objects and the use of the microfluidic sensor for the detection of analytes in fluids emitted by surfaces of objects, such as works of art or construction materials, for example, according to the set of claims.

A first aspect of the disclosure relates to a microfluidic sensor for the detection of analytes in an object. The microfluidic sensor comprises a contact surface configured to be attached to a surface of the object, for example, by means of an adhesive. It further comprises an inlet hole in the contact surface for the entry of fluids, for example, liquids or gases, emitted by the surface of the object and a first reservoir which stores an ionic fluid in the form of a polymer matrix. The polymer matrix comprises a reactive substance which is configured to change colour when it enters into contact with at least one analyte present in the fluids emitted by the surface of the object. The microfluidic sensor also comprises at least one first microfluidic duct which connects the inlet hole to the first reservoir. The microfluidic sensor is small sized and flexible, such that it can easily be fixed to the surface of the object of interest, regardless of the geometry of said surface. This at least one microfluidic duct or channel conducts the liquid and gases generated by the object from the surface of the object itself, through the inlet hole, to the first reservoir in which the polymer matrix with the reactive substance is located.

A user can visually detect the change in colour in the polymer matrix caused by the presence of the analyte of interest. Furthermore, a plurality of microfluidic sensors could be placed, each with a polymer matrix that stores a different reactive substance to detect the presence of different analytes on the same surface of an object of interest, for example, a work of art. Therefore, and given the small size of microfluidic sensors, the presence of a plurality of degradation factors can be monitored in a very small space.

In a particular embodiment, the reactive substance is configured to change colour by reaction with the at least one analyte at an intensity proportional to the concentration of the analyte, where the concentration-intensity ratio could be linear, quadratic or any other. Therefore, the greater the concentration of the analyte of interest, the greater the intensity of the colour resulting from the chemical reaction between the analyte and the reactive substance in the polymer matrix will be.

In another particular embodiment, the microfluidic sensor comprises a second reservoir configured to store moisture coming from the first reservoir and at least one second microfluidic duct which connects the first reservoir with the second reservoir. This second microfluidic duct or channel, which transports the moisture existing in the first reservoir to the second reservoir, and the second reservoir prevent the moisture from damaging the reactive substance or the polymer matrix containing same.

In another particular embodiment, the microfluidic sensor is formed by a first pressure-sensitive adhesive sheet having a first hole in correspondence with the inlet hole of the microfluidic sensor. It further comprises a sheet of poly(methyl methacrylate) (PMMA) comprising the inlet hole, the first reservoir and the at least one first microfluidic duct, a second pressure-sensitive adhesive sheet having a second hole in correspondence with the first reservoir and a sheet of cyclic olefin polymer (COP). The first pressure-sensitive adhesive sheet is adhered to the object and to the sheet of poly(methyl methacrylate), and the second pressure-sensitive adhesive sheet is adhered to the sheet of poly(methyl methacrylate) and to the sheet of cyclic olefin polymer. The adhesive of the face of the first pressure-sensitive adhesive sheet is selected such that it does not damage the surface of the object to which it is adhered, particularly if the microfluidic sensor is adhered to works of art. As an alternative to PMMA and COP, these sheets of the microfluidic sensor could be manufactured from polydimethylsiloxane (PDMS) or other materials compatible with the macroscale production of plastics that are transparent.

In another particular embodiment, the sheet of PMMA comprises the second reservoir and the at least one second microfluidic duct.

In another particular embodiment, the analyte is ammonia and the reactive substance is a water-soluble copper (II) salt. The microfluidic sensor is thereby capable of detecting the presence of ammonia in the object to which it is attached, for example, a work of art such as a historical building, a sculpture, a painting, etc. In another particular embodiment, the water-soluble copper salt is copper (II) chloride.

In another particular embodiment, the analyte is selected from a group comprising: chlorides, nitrates, carbonates, bicarbonates, sulphates, dissolved cations and any one combination of the foregoing. More generally, the analyte may be any analyte the anions of which can be analysed in a colorimetric sensor.

In another particular embodiment, the polymer matrix is formed by a compound selected from a group comprising an ion gel, a hydrogel, a porous polymer or poly(ionic liquids). More generally, the polymer matrix could be made of any material capable of retaining the sensing material, that is, the reactive substance, and the porosity of which makes it suitable for retaining liquids or gases.

In another particular embodiment, the ion gel is formed by ions selected from a group comprising cations of cholonium, imidazolium, phosphonium, ammonium, pyridinium, pyrrolidinium, among others, with a wide range of anions, for example, tetrafluoroborates, hexafluorophosphates, phosphates, perfluoro phosphates, perfluoro amides, bis(oxalate)borates, among others.

In another particular embodiment, the microfluidic sensor is transparent. The entire device is transparent so as to allow the colorimetric detection (of the change in colour) in the polymer matrix. Said colorimetric detection could be done visually or else by means of a detection unit configured to detect the change in colour of the reactive substance such as, for example, infrared spectrometers or Raman spectrometers, among others.

In another particular embodiment, the object is a work of art such as, for example, a painting, a mural, a sculpture, a historical building, construction materials, etc.

A second aspect of the disclosure relates to a system for the detection of analytes in an object, comprising a microfluidic sensor as described above and a detection unit configured to detect the change in colour of the reactive substance in the first reservoir of the microfluidic sensor.

In some embodiments, the detection unit comprises a camera for monitoring the microfluidic sensor and a digital image processing module to detect the change in colour of the reactive substance in the first reservoir of the microfluidic sensor from the images captured by the camera. The camera could be a video camera or a photographic camera configured to capture images of the microfluidic sensor on a periodic basis.

In some embodiments, the detection unit is selected from a group comprising an ultraviolet-visible spectrometer, an infrared spectrometer (IR) and a Raman spectrometer so as to allow the colorimetric/IR/Raman detection, respectively, of the reactive substance.

A third aspect of the disclosure relates to a method for the manufacture of a microfluidic sensor for the detection of analytes in objects, such as the one described above. The method comprises providing a contact surface configured to be attached to a surface of the object and providing an inlet hole in the contact surface for the entry of fluids emitted by the surface of the object. It further comprises providing a first reservoir which stores an ionic fluid, the ionic fluid comprising a reactive substance which is configured to change colour when it enters into contact with at least one analyte present in the fluids emitted by the surface of the object and providing at least one first microfluidic duct which connects the hole to the first reservoir.

In some embodiments, the method for the manufacture of the microfluidic sensor comprises providing a first pressure-sensitive adhesive sheet comprising the contact surface and having a first hole in correspondence with the inlet hole of the microfluidic sensor, providing a sheet of poly(methyl methacrylate) comprising the inlet hole, the first reservoir and the at least one first microfluidic duct, providing a second pressure-sensitive adhesive sheet having a second hole in correspondence with the first reservoir and providing a sheet of cyclic olefin polymer. In said embodiments, the first pressure-sensitive adhesive sheet is adhered to the sheet of poly(methyl methacrylate) and is configured to be adhered to the object, and the second pressure-sensitive adhesive sheet is adhered to the sheet of poly(methyl methacrylate) and to the sheet of cyclic olefin polymer.

A fourth aspect of the disclosure relates to the use of the microfluidic sensor for the detection of analytes in fluids emitted by surfaces of works of art such as, for example, paintings, murals, sculptures, historical buildings or works of art and heritage of another type. It also relates to the use of the microfluidic sensor for the detection of analytes in fluids emitted by surfaces of construction materials.

The microfluidic sensor for the detection of analytes in objects, the system for the detection of analytes, the method for the manufacture of a microfluidic sensor for the detection of analytes in objects and the use of the microfluidic sensor for the detection of analytes in fluids emitted by surfaces of objects, such as works of art or construction materials, for example, has a series of advantages over the state of the art. Said advantages are: it allows the monitoring and control of exudates in objects, such as works of art, which may be affected by different degradation factors or environmental contamination by means of wearable microfluidic technology and in an automatic and autonomous manner. It also allows the use of image monitoring techniques, such as video cameras or photographic analysis, or in combination with even more precise and specific detection techniques, such as Raman, IR, UV-Vis spectroscopy, among others, for the monitoring and control of said degradation factors. Furthermore, it is manufactured from flexible, low-cost materials that can be easily modified based on the analyte to be detected and on the object on which it is to be placed. Furthermore, use thereof has other advantages, among which its easy storage, transport and the fact that it is disposable stand out, all of which are very suitable for the inexpensive and rapid diagnosis in situ by untrained personnel, without the need for power sources or electronic components. The microfluidic sensor has very small dimensions, is portable, uses small volumes of sample, thereby reducing the amount of reagents, is highly sensitive and reliable and provides a response in a short period of time.

### BRIEF DESCRIPTION OF THE DRAWINGS

In order to complete the description and better understand the disclosure, a set of figures are provided. Said figures are an integral part of the description and illustrate different embodiments of the disclosure, which must not be interpreted as limiting the scope of the disclosure, but simply as examples of how the disclosure can be carried out.

FIG. 1 shows a front view of an example of a microfluidic sensor for the detection of an analyte, attached to a wall.

FIG. 2 shows an exploded perspective view of the example of the microfluidic sensor of FIG. 1.

FIG. 3 shows a view of an example of the system for the detection of analytes in an object.

FIG. 4 shows the absorption spectra of the ion gel (black/solid line), of the ion gel after having added copper chloride (blue/dashed) and of the ion gel with copper chloride after having reacted with ammonia (red/dotted)

FIG. 5A shows an experiment in which four microfluidic sensors are exposed to solutions with different concentrations of ammonium nitrate (through the exudate of the mortar) and a reference sensor (in which ammonium nitrate is not used, only water is). FIG. 5B shows a histogram in which the mean values of the colour parameter “H” are shown for the five microfluidic sensors (number of measurements of the value of “H” in the sensor being equal to three).

### DETAILED DESCRIPTION OF THE DRAWINGS

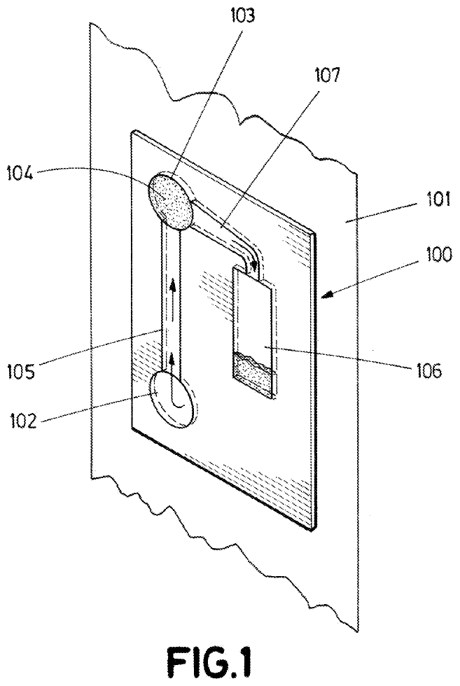

FIG. 1 shows a front view of an example of a microfluidic sensor 100 for the detection of analytes, for example, the ammonia given off after the ammonium reacts with the mortar, attached to a wall 101. It should be understood that the microfluidic sensor 100 depicted in FIG. 1 may include additional components and that some of the components described here can be eliminated and/or modified without departing from the scope of the microfluidic sensor 100.

The microfluidic sensor 100 is attached to a wall 101 for the detection and monitoring of the impact of the ammonium cation on the construction materials of said wall 101. The microfluidic sensor 100 comprises an inlet hole 102 for the exudates coming from the wall 101, where these exudates may contain the ammonium cation, in addition to other anions, cations and substances such as, for example, water and ammonia. The microfluidic sensor 100 additionally has a first reservoir 103 in which there is stored an ion gel 104 in ionic liquid in the form of a polymer matrix acting as a support to contain a reactive substance, in this case, copper chloride (CuCl₂), although it could be any soluble Cu²⁺ salt. The reactive substance is embedded in the polymer matrix, where the structure of the polymer matrix allows the storage of the reactive substance for long periods of time without it deteriorating, while at the same time allowing it to react with the analyte of interest to work as a colorimetric sensor.

The first reservoir 103 has a configuration which allows the exudates, liquids and/or gases to pass through the ion gel 104. The microfluidic sensor 100 is manufactured in a transparent material so as to allow the colorimetric/IR/Raman detection in the polymer matrix, and it has a low rigidity that allows it to be attached to surfaces with varying geometries.

The microfluidic sensor 100 further comprises a first microfluidic duct 105 which communicates the inlet hole 102 with the first reservoir 103 for transporting the exudates from the wall 101 to the first reservoir 103. It further comprises a second reservoir 106 for storing the moisture that comes from the first reservoir 103 and is transported from the first reservoir 103 through a second microfluidic duct 107.

The ion gel 104 could be formed by ionic liquids based on thiazolium, benzothiazolium, phosphonium and imidazolium, among others. Furthermore, the ion gel 104 could contain other reactive substances for controlling other analytes of interest such as, for example, hydrogen cations for the detection of the pH or of variations in the redox potential, chlorides, nitrates, nitrites, carbonates, bicarbonates, sulphates, dissolved cations, among others.

As an alternative to the ion gel 104, the first reservoir 103 could contain hydrogels, porous polymers or poly(ionic liquids) in the form of a polymer matrix, depending on the detection needs of the microfluidic sensor 100. Hydrogels are polymerised, crosslinked, porous structures with hydrophilic properties that are capable of retaining a significant fraction of water therein. Hydrogels are generally prepared from hydrophilic monomers, although hydrophobic monomers can also be used to regulate the properties for specific applications. For example, the hydrogels could be polyacrylamides.

In this example of a microfluidic sensor 100, copper (II) chloride reacts with the ammonia coming from the exudates of the wall 101 such that the copper (II) cation forms a stable compound with the ammonia, and the colour changes from greenish yellow to blue, according to the reaction:

CuCl₂+4 NH₃ [symbol] [Cu(NH₃)₄] Cl₂

Gradually, the copper chloride (CuCl₂) reacts with ammonia fumes, and when the reaction is complete and the copper and ammonia metal complex ([Cu(NH₃)₄]Cl₂) is formed, the sensor changes colour from greenish yellow to blue.

In this example, the ion gel 104 is obtained using the ILs (IO-1) 1-ethyl-3-methylimidazolium ethyl sulphate. The ion gel is synthesised by mixing two monomers, a first linear monomer (N-isopropylacrylamide) and a second crosslinking monomer (N,N′-methylene-bisacrylamide) to give the three-dimensional structure, and as a result of its positive and negative charges, it ensures that the structure of the polymer matrix does not collapse while at the same time improves the plasticity of the gel. Furthermore, a photoinitiator (2,2-dimethoxy-2-phenylacetophenone) is added to induce photopolymerisation at a wavelength of 365 nm. To that end, with a mechanical pipette, 75 μl of the solution with the two monomers together with the photoinitiator are even placed in a support. The solution is subsequently subjected to a photopolymerisation process with a 365 nm wavelength UV-VIS lamp for 5 minutes. The ion gel 104 resulting from the ionic liquids is washed with isopropanol and distilled water and dried with absorbent paper to remove any residue of the unreacted monomers and of any other reagent. Then, 75 μl of a 0.3 M solution of copper chloride in ethanol are poured over the ion gel for it to dry. Finally, the sensor is washed with distilled water and dried with absorbent paper.

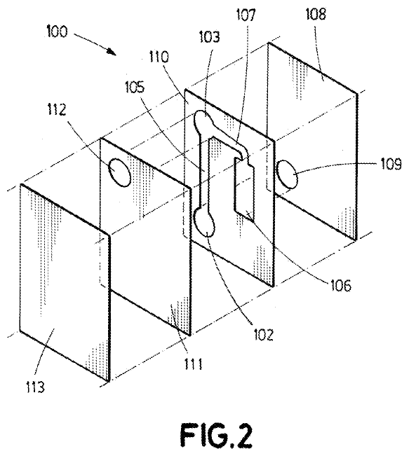

FIG. 2 shows an exploded perspective view of the example of the microfluidic sensor 100 of FIG. 1. The microfluidic sensor 100 is manufactured using multilayer lamination protocols.

The microfluidic sensor 100 comprises four layers. In principle, the layers forming the microfluidic sensor 100 can be of any material provided that it is inert to the materials with which it will enter into contact, that is, it does not react and does not interfere with the chemistry of the polymer matrix, the reactive substances contained in the polymer matrix, or with the chemical compounds coming from the exudates of the object intended to be monitored. Examples of plastic materials suitable for the layers are, among others, high density polyethylene, low density polyethylene, polyethylene terephthalate, polyvinyl chloride, polypropylene, polystyrene or polycarbonate, cyclic olefin polymer or copolymer or acrylic resins.

In this example, the microfluidic sensor 100 comprises a first pressure-sensitive adhesive layer 108, cut with a cutting plotter (Graphtec CE5000-40 Craft Robo Pro), which contains a first hole 109 in correspondence with the inlet hole 102. The first pressure-sensitive adhesive layer is adhesive on both faces, with an external face which is adhered to the object to be monitored, in this case to the wall 101, and an internal face which is adhered to an internal poly(methyl methacrylate) (PMMA) layer 110. The internal PMMA layer 110 is manufactured by means of a CO₂ laser ablation system (Laser Micro-machining Light Deck). This internal PMMA layer comprises the inlet hole 102, the first microfluidic duct 105, the first reservoir 103, the second microfluidic duct 107 and the second reservoir 106. The internal PMMA layer has higher rigidity, is slightly thicker (e.g., around 1 mm) and has a higher mechanical strength than the other three layers forming the microfluidic sensor 100.

The second microfluidic duct 107 which connects the first reservoir 103 with the second reservoir 106 transports the moisture reaching the ion gel 104 to the second reservoir 103 in which it is stored. By means of removing the moisture from the polymer matrix, the service life of the microfluidic sensor 100 is prolonged. It can also be used as a qualitative way to measure the moisture exudated by the object intended to be monitored. The dimensions of the second reservoir 106 may vary depending on the object to which the microfluidic sensor is attached, being larger when a larger amount of moisture exudated by the object is expected.

The microfluidic sensor 100 has a second pressure-sensitive adhesive layer 111 which is adhered on one side to the internal PMMA layer 110 and on the other side to a cyclo olefin polymer (COP) layer 113. The second pressure-sensitive adhesive layer 111 has a hole 112 in correspondence with the first reservoir 103 such that the space of the first reservoir 103 is defined by the first pressure-sensitive adhesive layer 108, the PMMA layer 110 and the COP layer 113. This layer COP 113 allows complete transparency of the detection area of the first reservoir 103 and keeps the ion gel 104 in the front and outermost area of the microfluidic sensor 100. Preferably, all the layers of the microfluidic sensor 100 are made of a transparent material.

In this specific example, to manufacture the microfluidic sensor 100, the first pressure-sensitive adhesive layer 108 is placed and the PMMA layer 110 is adhered to same. Then, 5 μl of ILs (IO-1) 1-ethyl-3-methylimidazolium ethyl sulphate are placed in the first reservoir 103, and photopolymerisation is performed with a UV-VIS lamp for 1 min to form the ion gel 104. Alternatively, the ion gel 104 could be obtained in a separate container, and an amount could be taken from same and deposited in the first reservoir 103 in which photopolymerisation would be carried out. Next, the ion gel 104 is washed with isopropanol and distilled water and dried with absorbent paper. Subsequently, 5 μl 0.3 M solution of copper chloride in ethanol is added to the ion gel 104, and the ion gel 104 is washed again with water and dried. Finally, the second pressure-sensitive adhesive layer 111 and the COP layer 113 are placed. Lastly, the microfluidic sensor 100 is placed on the surface to be monitored. This design allows the simple ocular viewing of the change in colour in the polymer matrix containing the ion gel 104. It also allows the use of electronic detection units, for example, spectrometers, for the detection of the change in colour in the polymer matrix.

The amount of ion gel 104 which is deposited in the first reservoir 103 is variable and will depend in each case on the design of the microfluidic sensor 100.

Although FIGS. 1 and 2 show a microfluidic sensor 100 with a very specific geometry and arrangement of the elements, the dimensions of the microfluidic sensor 100 may be variable and there is no particular limitation in this regard. The size of the microfluidic sensor 100 may vary depending on the analysis requirements and on the object on which it is to be placed, among other parameters. In a particular embodiment, the device is 1.5 mm thick and measures 3×3 cm. Likewise, the dimensions, arrangements and shapes of the reservoirs, microfluidic openings and ducts may also vary in the microfluidic sensor 100, without there being any particular limitation in that regard either.

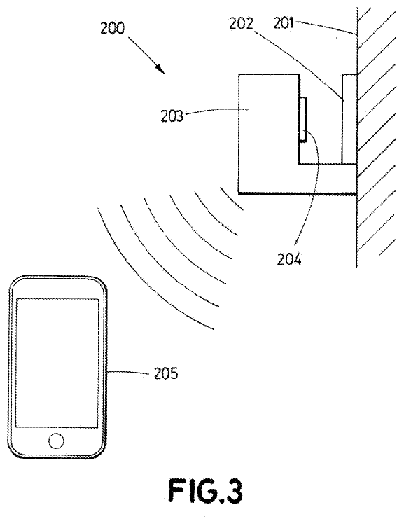

FIG. 3 shows a view of an example of a system for the detection 200 of analytes in an object, for example, a wall 201, including the microfluidic sensor 202 and a detection unit 203 configured to detect the change in colour of the reactive substance in the first reservoir of the microfluidic sensor 202. It should be understood that the system 200 for the detection depicted in FIG. 3 may include additional components and that some of the components described here can be eliminated and/or modified without departing from the scope of the system 200 for the detection.

The system 200 for the detection of analytes, for example, ammonia, in a construction material of a building, for example, the wall 201 of a building, comprises a microfluidic sensor 202, for example, such as the one described in FIGS. 1 and 2, attached to said wall 201. It further comprises a detection unit 203 configured to detect the change in colour in the microfluidic sensor 202. This detection unit 203 is formed by an ultraviolet-visible spectrometer (not shown) connected to a video camera 204 monitoring the microfluidic sensor 202. The detection unit 203 also houses a digital image processing module integrated in the spectrometer which is configured to detect the change in colour of the reactive substance in the microfluidic sensor 202. Both the video camera 204 and the spectrometer and the digital image processing module are integrated inside the casing of the detection unit 203.

The detection unit 203 has wireless communication means, for example, a Bluetooth or WiFi connection, for sending the captured image processing results to a remote device 205, such as a computer, a mobile telephone, an iPad, a PDA, etc.

Alternatively, the detection unit 203 could have an infrared spectrometer or a Raman spectrometer also connected to the video camera 204 and to the digital image processing module integrated in the spectrometer. In other examples, as an alternative to the video camera 204, the detection unit could have a photographic camera programmed to capture images of the microfluidic sensor 202 on a periodic basis.

Said detection unit 203 could be attached to the wall 201 and located in proximity to the microfluidic sensor 202, or it could be attached directly to the microfluidic sensor 202, provided that the camera 204 is aligned with the first reservoir of the microfluidic sensor 202 for the colorimetric monitoring of the polymer matrix.

Alternatively, the system 200 for the detection could be a mobile telephone or a similar device, capable of taking pictures of the microfluidic sensor 202, and said image could subsequently be analysed remotely with the appropriate software; or in situ if the mobile phone has the appropriate image analysis programme.

For analysis of the captured images of the microfluidic sensor, the digital image processing module could use software such as ImageJ® or other more complex analytical tools (colorimetric analysis apparatus, optical fibres, spectrometers, etc.).

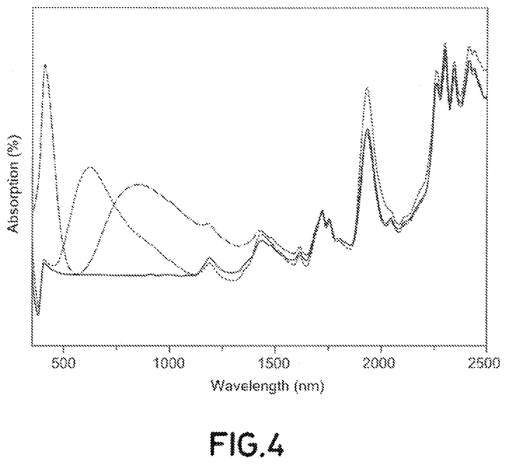

FIG. 4 shows the absorption spectra of the ion gel (black/solid line), of the ion gel after having added copper chloride (blue/dashed) and of the ion gel with copper (II) chloride after having reacted with ammonia (red/dotted).

These spectra have been obtained by means of UV-VIS-NIR spectrophotometric techniques and correspond to a single microfluidic sensor such as the one described in relation to FIG. 2. Therefore, the analyses were performed on the ion gel samples as such, after adding copper (II) chloride and after reacting with ammonia. The UV-VIS-NIR spectrum obtained for the microfluidic sensor with just the ion gel shows frequency bands located at 1430, 1615, 1933 and 2260 nm. The UV-VIS-NIR spectrum obtained for the microfluidic sensor with the copper chloride solution shows maximum absorption of the Cu²⁺ ion in solution at 415 nm, that is, in the orangish and yellow region of the electromagnetic spectrum. After the reaction with ammonia and the formation of the metal complex, the UV-VIS-NIR spectrum obtained for the microfluidic sensor shows a shift of the main emission band at about 615 nm, which corresponds with the maximum absorption of the compound Cu(NH₃)₄²⁺, in the blue region of the electromagnetic spectrum. This is why the human eye perceives the chromatic change from yellows to blues in the polymer matrix.

Said spectra demonstrate the viability of the detection by means of visual techniques (human eye) and spectrophotometry to verify the formation of the metal complex [Cu(NH₃)₄]Cl₂] which denotes the presence of the analyte of interest.

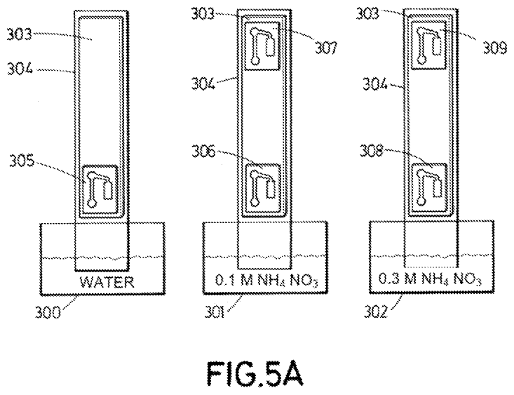

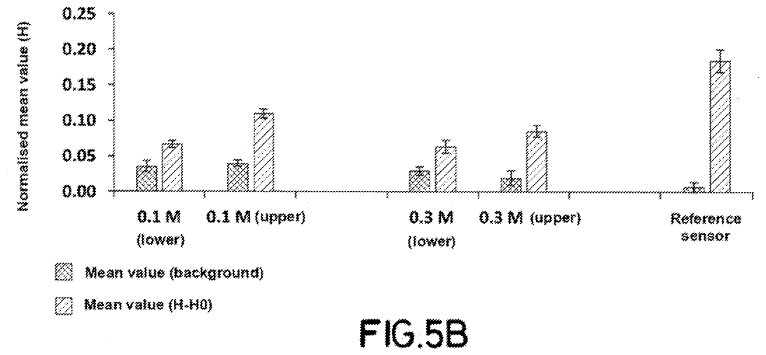

FIG. 5A shows an experiment in which four microfluidic sensors are exposed to solutions with different concentrations of ammonium nitrate (through the exudate of the mortar) and a reference sensor (in which ammonium nitrate is not used, only water is). FIG. 5B shows a histogram which shows the mean values of the colour parameter “H” detected in the five microfluidic sensors exposed to solutions with different concentrations (0.1 M, 0.3 M) of ammonium nitrate and in a microfluidic reference sensor, obtained by means of spectrophotometric techniques and ImageJ® software.

To carry out this experiment, which is an illustrative example of how the disclosure works which should not in any case be interpreted as limiting the scope of protection of the disclosure, the ammonium nitrate was reproduced in the laboratory. This ammonium nitrate (NH₄NO₃) was obtained by mixing ammonium chloride (NH₄Cl) and potassium nitrate (KNO₃). Three solutions of ammonium chloride and potassium nitrate dissolved in milli-Q water at different concentrations (0.1 and 0.3 M) were prepared. In this case, the analyte to be detected is ammonium (NH₄⁺) after being transformed into ammonia after reacting with the construction material.

The solutions were placed inside different plastic containers 300-302 closed with a lid, and mortar samples 303 supported by metal rods and laboratory clamp (not shown) were placed above same. By means of a fine opening in the cover, filter paper 304 was used to act as a vehicle between the solutions and the mortar samples 303. Other samples were exposed to ammonium nitrate fumes to verify if they could detect NH₃ fumes. For the same reason and to have a reference, a microfluidic sensor 305 was placed in contact with a solution of only water. For the 0.1 M solution with NH₄NO₃, two microfluidic sensors were used, one in the lower part 306 and the other one in the upper part 307, simulating two different heights. For the 0.3 M solution with NH₄NO₃, two microfluidic sensors were used, one in the lower part 308 and the other one in the upper part 309, simulating the same heights as the microfluidic sensors 306-307. The microfluidic sensor 306 placed in the lower part and exposed to the 0.1 M solution showed, after one month, a change in colour from yellow to light blue. Moreover, the microfluidic sensor 307 placed in the upper part (13 cm above the other sensor) in the same scale model 303 did not show any evidence of a change in colour since the solution did not reach the inlet hole of the microfluidic sensor 307 by capillarity after one month of experiment. Furthermore, the reference microfluidic sensor 305 placed in the lower part of the scale model 303 with the water and filter paper 304 did not show any change in colour.

Thus, the scale models 303 were placed in a moist place (around the 90% moisture content) where they remained for 7 months exposed to the fumes and to the solutions of ammonium nitrate. After 7 months, both sensors 306-307 exposed to the 0.1 M solution showed a clear change in colour, particularly sensor 306.

The microfluidic sensors 308-309 which were exposed to solutions with higher concentrations (0.3 M) showed a similar chromatic variation, probably due to the long duration of the experiment, in which all the sensors could have reached a steady state in colour formation.

In all cases, due to the high moisture content, the presence of water in the second reservoir was observed, testing the viability of this reservoir for the proper working of the microfluidic device sensor.

Those sensors that showed a more apparent bluish colouring were those that were exposed to solutions with higher concentrations of ammonium nitrate, sensors 308-309. To verify these tests by means of an analytical method, the change in colour was evaluated in relation with the concentration of the solutions using the open-source software ImageJ® (Fiji) created for processing images after taking a photograph of the different microfluidic sensors. Thus, ImageJ® software, using the “Colour transformer” plugin, calculated the HVS values (which is a colour model defined in terms of its components, (https://es.wikipedia.org/wiki/ldioma_inglés Hue, Saturation Value https://es.wikipedia.org/siki/Matiz_(color)https://es.wikipedia.org/wiki/Saturación_(color)https://es.wikipedia.org/wiki/Valor_(color)). Subsequently, the areas of interest were selected and then the H value was extracted both from the background (taken in an area of the sensor with the background of the scale model) and from the area of the sensor in which the ion gel was located. Thus, ImageJ® software calculated the H0 value of the background which was subtracted from the H value of the sensor.

The values obtained by the graph of the results were compatible with the intensity of the blue colour of the sensors after 7 months of exposure to solutions at different concentrations (0.1, 0.3 M and reference), as can be seen in the histogram which is shown in FIG. 5B. The reference value was taken from a photograph taken of a microfluidic sensor before beginning the experiment, and it shows the highest H value since no reaction took place. Low H values were obtained for the sensors exposed to 0.1 M solutions, the lowest values being obtained for the sensors exposed to the 0.3 M solutions. In fact, the more intense the colour of the sensor is (bluish), the lower the H values are.

Furthermore, the average H value was also calculated based on the position of the sensor in the scale model (lower or higher). The H value was lower in the sensor located in the lower area of the mortar, sensors 306, 308, because it is the sensor closest to the solutions and the one that most detects the presence of ammonium. The same situation was observed for both concentrations (0.1 and 0.3 M). This protocol demonstrated the possibility of using simple image analysis techniques (extracting analytical information about a change in colour from an image) to characterise the performance of the microfluidic sensor.

The disclosure is not limited to the specific embodiments described herein, but rather encompasses, for example, the variants that a person skilled in the art could make, within the scope of what may be deduced from the claims.

1. A microfluidic sensor for the detection of analytes in an object, it the microfluidic sensor comprises:
a contact surface configured to be attached to a surface of the object;
an inlet hole in the contact surface for the entry of fluids emitted by the surface of the object;
a first reservoir which stores an ionic fluid in the form of a polymer matrix, the polymer matrix comprising a reactive substance which is configured to change colour when it enters into contact with at least one analyte present in the fluids emitted by the surface of the object; and
at least one first microfluidic duct which connects the inlet hole to the first reservoir.

2. The microfluidic sensor according to claim 1, wherein the reactive substance is configured to change colour by reaction with the at least one analyte at an intensity proportional to the concentration of the analyte.

3. The microfluidic sensor according to claim 1, comprising:
a second reservoir configured to store moisture coming from the first reservoir; and
at least one second microfluidic duct which connects the first reservoir to the second reservoir.

4. The microfluidic sensor according to claim 1, comprising:
a first pressure-sensitive adhesive sheet having a first hole in correspondence with the inlet hole of the microfluidic sensor;
a sheet of poly(methyl methacrylate) comprising the inlet hole, the first reservoir and the at least one first microfluidic duct;
a second pressure-sensitive adhesive sheet having a second hole in correspondence with the first reservoir; and
a sheet of cyclic olefin polymer,
wherein the first pressure-sensitive adhesive sheet is adhered to the object and to the sheet of poly(methyl methacrylate), and wherein the second pressure-sensitive adhesive sheet is adhered to the sheet of poly(methyl methacrylate) and to the sheet of cyclic olefin polymer.

5. The microfluidic sensor according to claim 4, wherein the sheet of poly(methyl methacrylate) comprises the second reservoir and the at least one second microfluidic duct.

6. The microfluidic sensor according to claim 1, wherein the analyte is ammonia and the reactive substance is a water-soluble copper (II) salt.

7. The microfluidic sensor according to claim 6, wherein the water-soluble copper salt is copper (II) chloride.

8. The microfluidic sensor according to claim 1, wherein the analyte is selected from a group consisting of:
chlorides, nitrates, carbonates, bicarbonates, sulphates, dissolved cations, and any one combination of the foregoing.

9. The microfluidic sensor according to claim 1, wherein the polymer matrix is selected from a group consisting of: an ion gel, a hydrogel, porous polymers, or poly(ionic liquids).

10. The microfluidic sensor according to claim 9, wherein the ion gel is formed by ions selected from a group consisting of: thiazole, benzothiazole, phosphonium, and imidazole.

11. The microfluidic sensor according to claim 1, wherein the microfluidic sensor is transparent.

12. The microfluidic sensor according to claim 1, wherein the object is a work of art.

13. A system for the detection of analytes in an object, the system comprising:
a microfluidic sensor according to claim 1; and
a detection unit configured to detect the change in colour of the reactive substance in the first reservoir of the microfluidic sensor.

14. The system for the detection of analytes according to claim 13, wherein the detection unit comprises a camera for monitoring the microfluidic sensor and a digital image processing module to detect the change in colour of the reactive substance in the first reservoir of the microfluidic sensor.

15. The system for the detection of analytes according to claim 13, wherein the detection unit is selected from a group consisting of: an ultraviolet-visible spectrometer, an infrared spectrometer, and a Raman spectrometer.

16. A method for the manufacture of the microfluidic sensor of claim 1, the method including the following steps:
providing a contact surface configured to be attached to a surface of the object;
an inlet hole in the contact surface for the entry of fluids emitted by the surface of the object;
a first reservoir which stores an ionic fluid, the ionic fluid comprising a reactive substance which is configured to change colour when it enters into contact with at least one analyte present in the fluids emitted by the surface of the object; and
at least one first microfluidic duct which connects the hole to the first reservoir.

17. The method for manufacturing the microfluidic sensor of claim 16, the method including the following steps:
providing a first pressure-sensitive adhesive sheet comprising the contact surface and having a first hole in correspondence with the inlet hole of the microfluidic sensor;
providing a sheet of poly(methyl methacrylate) comprising the inlet hole, the first reservoir and the at least one first microfluidic duct;
providing a second pressure-sensitive adhesive sheet having a second hole in correspondence with the first reservoir; and
providing a sheet of cyclic olefin polymer,
wherein the first pressure-sensitive adhesive sheet is adhered to the object and to the sheet of poly(methyl methacrylate), and wherein the second pressure-sensitive adhesive sheet is adhered to the sheet of poly(methyl methacrylate) and to the sheet of cyclic olefin polymer.

18. Use of the microfluidic sensor of claim 1 for the detection of analytes in fluids emitted by surfaces of works of art.

19. Use of the microfluidic sensor of claim 1 for the detection of analytes in fluids emitted by surfaces of construction materials.
